(19) United States
(12) Patent Application Publication
(10) Pub. No.: US 2014/0123141 A1
(43) Pub. Date: May 1, 2014

(54) COMPUTING DEVICE AND VIRTUAL MACHINE ACCESSING METHOD

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); CHIU-HUA LU, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 14/022,256

(22) Filed: Sep. 10, 2013

(30) Foreign Application Priority Data
Oct. 30, 2012 (TW) 101140189

(51) Int. Cl. G06F 9/455

(52) U.S. Cl. CPC G06F 9/45533
USPC 718/1

(57) ABSTRACT

In a virtual machine (VM) accessing method, a computing device obtains instantaneous information of a virtual machine in the computing device. The instantaneous information of the virtual machine is converted into a format supported by webpages. The computing device provides the converted instantaneous information of the virtual machine to a web server connected to the computing device, so that a client computer connected to the web server can access the virtual machine.

### BACKGROUND

1. Technical Field

Embodiments of the present disclosure relate to virtual machine technology, and particularly to a computing device and a virtual machine accessing method of the computing device.

2. Description of Related Art

A physical machine such as a server can have a number of virtual machines (VMs) installed for providing multiple services to users. However, certain dedicated applications need to be installed in client computers to access the virtual machines, and the dedicated applications vary for different operating systems of the client computers. Therefore, it is inconvenient to access the virtual machines when the client computers are installed with different operating systems.

### BRIEF DESCRIPTION OF THE DRAWINGS

FIG. 1 is one embodiment of an application of a computing device including a virtual machine (VM) accessing system.

FIG. 2 is a block diagram of one embodiment of function modules of the VM accessing system in FIG. 1.

FIG. 3 is a flowchart of one embodiment of a virtual machine accessing method of the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

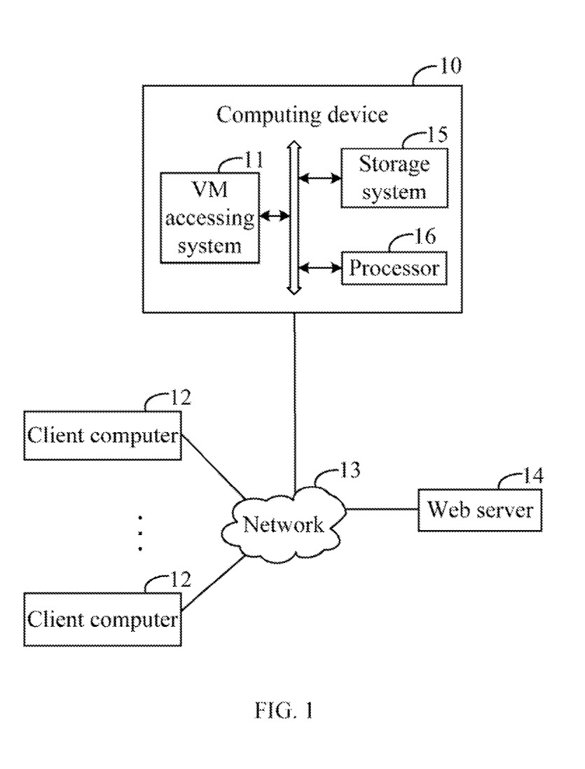

FIG. 1 is one embodiment of an application of a computing device 10 including a virtual machine (VM) accessing system 11. The computing device 10 is connected to a plurality of client computers 12 and a web server 14 through a network 13. One or more virtual machines (not shown) are installed in the computing device 10 to provide services (e.g., computing services) to users. Each of the client computers 12 includes a web browser (not shown). The VM accessing system 11 allows the client computers 12 to access the virtual machines without installing any specialized application. The network 13 can be a public network or a private network.

In this embodiment, the computing device 10 further includes a storage system 15 and at least one processor 16. The storage system 15 can be a dedicated memory, such as an EPROM, a hard disk drive (HDD), or flash memory. In some embodiments, the storage system 15 can be an external storage device, such as an external hard disk, a storage card, or a data storage medium.

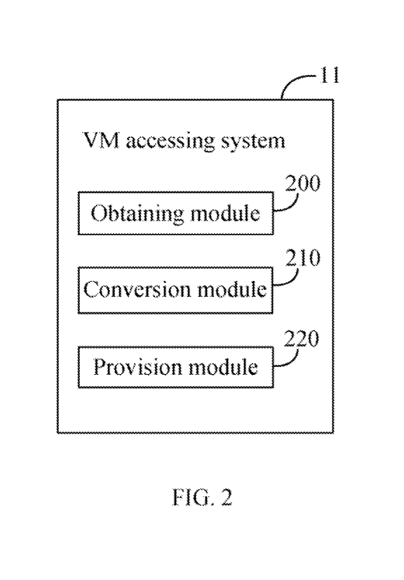

FIG. 2 is a block diagram of one embodiment of function modules of the VM accessing system 11 in FIG. 1. The VM accessing system 11 includes an obtaining module 200, a conversion module 210, and a provision module 220. The modules 200-220 can comprise computerized code in the form of one or more programs that are stored in the storage system 15. The computerized code includes instructions that are executed by the processor 16, to provide the aforementioned functions of the VM accessing system 11. Detailed descriptions of the functions of the modules 200-220 are explained in the following descriptions of a VM accessing method of the computing device 10.

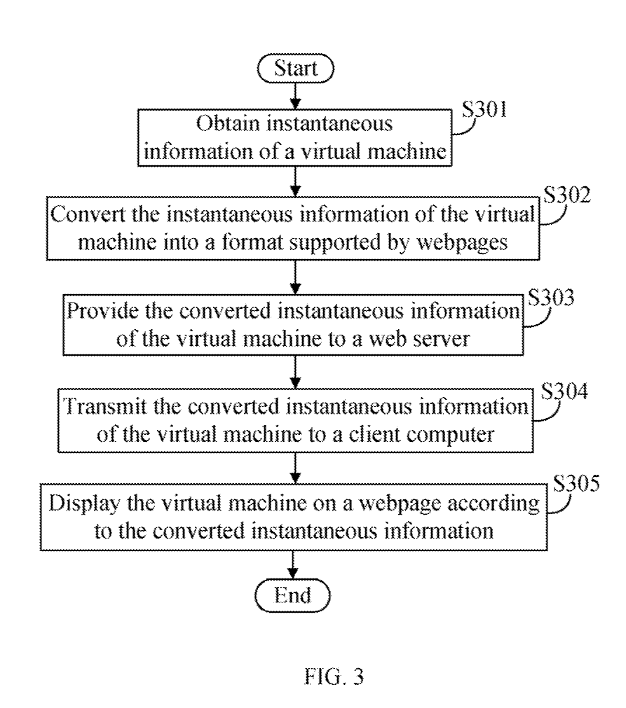

FIG. 3 is a flowchart of one embodiment of a VM accessing method of the computing device 10 of FIG. 1. Depending on the embodiment, additional steps can be added, others removed, and the ordering of the steps can be changed.

In step S301, the obtaining module 200 obtains instantaneous information of a virtual machine in the computing device 10. The instantaneous information of the virtual machine includes instantaneous image information and instantaneous sound information of the virtual machine. The instantaneous image information is used to display an instantaneous image of a screen of the virtual machine. The instantaneous sound information is used to play an instantaneous sound of the virtual machine.

In step S302, the conversion module 210 converts the instantaneous information of the virtual machine into a format supported by webpages. In one embodiment, the conversion module 210 adds tags (e.g., HTML tags) to the instantaneous information. For example, the conversion module 210 adds video tags to the instantaneous image information and adds audio tags to the instantaneous sound information. In accordance with the instantaneous image information and the video tags, an instantaneous image of the screen of the virtual machine is displayed on a webpage. In accordance with the instantaneous sound information and the audio tags, an instantaneous sound of the virtual machine is played on the webpage. In one embodiment, the conversion module 210 compresses the instantaneous information of the virtual machine before converting the instantaneous information into the format supported by webpages.

In step S303, the provision module 220 provides the converted instantaneous information of the virtual machine to the web server 14. In this embodiment, the provision module 220 provides the converted real-time image information and the converted real-time sound information of the virtual machine to the web server 14.

In step S304, the web server 14 receives a VM access request from a client computer 12 and transmits the converted instantaneous information of the virtual machine to the client computer 12 in response to the VM access request. In one embodiment, the client computer 12 submits the VM access request via the web browser. In response to the VM access request, the web server 14 transmits the converted instantaneous information to the web browser of the client computer 12.

In step S305, the client computer 12 receives the converted instantaneous information from the web server 14, and uses the web browser to display the virtual machine on a webpage according to the converted instantaneous information. In one embodiment, the webpage displays the instantaneous image of the screen of the virtual machine and plays the instantaneous sound of the virtual machine.

In one embodiment, if instantaneous information of the virtual machine received from the computing device 10 is not supported by a webpage, the client computer 12 converts the instantaneous information into a format that is supported by the webpage, and provides the converted instantaneous information to the web server 14. Therefore, other client computers 12 can access the virtual machines without installing any specialized application according to the converted instantaneous information.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A virtual machine accessing method being executed by a processor of a computing device, the method comprising:
obtaining instantaneous information of a virtual machine in the computing device;
converting the instantaneous information of the virtual machine into a format supported by webpages; and
providing the converted instantaneous information of the virtual machine to a web server connected to the computing device.

2. The method of claim 1, wherein the instantaneous information of the virtual machine comprises instantaneous image information and instantaneous sound information of the virtual machine.

3. The method of claim 1, wherein the instantaneous information of the virtual machine is compressed before the instantaneous information is converted into the format supported by webpages.

4. The method of claim 1, wherein the instantaneous information is converted into the format supported by webpages by adding tags to the instantaneous information.

5. The method of claim 1, wherein one or more client computers receive the converted instantaneous information from the web server and display the virtual machine on the webpage according to the converted instantaneous information.

6. A computing device, comprising:
at least one processor; and
a storage system storing a plurality of instructions, which when executed by the at least one processor, cause the at least one processor to:
obtain instantaneous information of a virtual machine in the computing device;
convert the instantaneous information of the virtual machine into a format supported by webpages; and
provide the converted instantaneous information of the virtual machine to a web server connected to the computing device.

7. The computing device of claim 6, wherein the instantaneous information of the virtual machine comprises instantaneous image information and instantaneous sound information of the virtual machine.

8. The computing device of claim 6, wherein the instantaneous information of the virtual machine is compressed before the instantaneous information is converted into the format supported by webpages.

9. The computing device of claim 6, wherein the instantaneous information is converted into the format supported by webpages by adding tags to the instantaneous information.

10. The computing device of claim 6, wherein one or more client computers receive the converted instantaneous information from the web server and display the virtual machine on a webpage according to the converted instantaneous information.

11. A non-transitory computer-readable storage medium storing a set of instructions, the set of instructions capable of being executed by a processor of a computing device to implement a virtual machine accessing method, the method comprising:
obtaining instantaneous information of a virtual machine in the computing device;
converting the instantaneous information of the virtual machine into a format supported by webpages; and
providing the converted instantaneous information of the virtual machine to a web server connected to the computing device.

12. The storage medium of claim 11, wherein the instantaneous information of the virtual machine comprises instantaneous image information and instantaneous sound information of the virtual machine.

13. The storage medium of claim 11, wherein the instantaneous information of the virtual machine is compressed before the instantaneous information is converted into the format supported by webpages.

14. The storage medium of claim 11, wherein the instantaneous information is converted into the format supported by webpages by adding tags to the instantaneous information.

15. The storage medium of claim 11, wherein one or more client computers receive the converted instantaneous information from the web server display the virtual machine on a webpage according to the converted instantaneous information.
